(19) United States
(12) Patent Application Publication
(10) Pub. No.: US 2013/0262364 A1
(43) Pub. Date: Oct. 3, 2013

(54) Clinical Documentation Debugging Decision Support

(71) Applicant: Alexander Adrianus Martinus Verbeek, Eindhoven (NL)

(72) Inventor: Alexander Adrianus Martinus Verbeek, Eindhoven (NL)

(73) Assignee: KONINKLIJKE PHILIPS ELECTRONICS N.V., Eindhoven (NL)

(21) Appl. No.: 13/992,845

(22) PCT Filed: Dec. 2, 2011
(86) PCT No.: PCT/IB2011/055438

§ 371 Date: Jun. 10, 2013

(30) Foreign Application Priority Data
Dec. 10, 2010 (EP) 10194522.8

(51) Int. Cl. G06N 5/02

(52) U.S. Cl. CPC G06N 5/02
USPC 706/46

(57) ABSTRACT

A system for verifying document content comprising a knowledge base (1) comprising a collection of knowledge-base expressions (2) and a collection of knowledge-base relations (3) between the knowledge-base expressions (2). A database (4) is provided comprising a record (5) with documents comprising information relating to an entity, the documents including free-text documents (6) and/or structured documents (7). A natural language processor (8) is provided for extracting record expressions (10) from free-text documents (6) stored in the record (5) and for determining record relations (11) between the record expressions (10) based on the free-text documents (6). An analysis engine (12) is provided for analyzing the record expressions (10) and the record relations (11) also based on the knowledge-base relations (3) to detect an irregularity in the record (5). A notifier (14) is provided for providing a notification to a user in dependence on an output of the analysis engine (12). Record expressions (10) and/or record relations (11) matching knowledge-base expressions (2) and/or knowledge-base relations (3) are extracted.

### FIELD OF THE INVENTION

The invention relates to verifying document content.

### BACKGROUND OF THE INVENTION

The quality of clinical documentation created by clinicians in electronic medical records and/or reporting systems is of great importance for successful patient care. The different aspects of a disease or medical condition that are documented are frequently linked to each other, for example by strict rule-based relations. A simple example of such a rule is that the size of a tumor is one of the determinants of the stage of a cancer, and the stage is one of the determinants of a particular treatment. However, because different aspects of a disease are often documented at different times in the workflow, by different stakeholders (e.g. a radiologist, nurse, oncologist), and across multiple reports, it often occurs that a medical record is inconsistent, incomplete or incorrect. For example, the recent paper “Omitted and unjustified medications in the discharge summary”, by Perren A, Previsdomini M, Cerutti B, Soldini D, Donghi D, Marone C, in: Qual Saf Health Care, June 2009, 18 (3):205-8 describes that of 577 of the evaluated discharge letters, 66% contained at least one inconsistency accounting for a total of 1012 irregularities. There were 393 drug omissions affecting 251 patients, 32% of which were potentially harmful. Seventeen percent of all medications (619/3691) were unjustified, affecting 318 patients. Even when such irregularities are detected, it takes a lot of time to resolves these issues, and if unnoted such issues may result in medical errors.

Currently, some systems provide data consistency control, but this is limited to strongly structured data entered in single source electronic form. The same applies to completeness checking where the user is notified if (s)he has not filled in all mandatory fields in an electronic form.

EP 1 594 070 A2 discloses an automatic database file system maintenance and repair system to ensure data reliability and consistency with regard to a data model. The system comprises physical data correction responding to and correcting physical data corruptions. The system further comprises logical data correction responding to and correcting logical data corruptions for “entities”, e.g., items, extensions, and/or relationships in an item-based operating system. The cited document further discloses analyzing and correcting logical “damage” to entities to ensure that all such entities are both consistent and conform to the data model rules.

### SUMMARY OF THE INVENTION

It would be advantageous to have an improved verification of document content. To better address this concern, a first aspect of the invention provides a system comprising

a knowledge base comprising a collection of knowledge-base expressions and a collection of knowledge-base relations between the knowledge-base expressions;

a database comprising a record with documents comprising information relating to an entity, the documents including free-text documents and/or structured documents;

a natural language processor for extracting record expressions from free-text documents stored in the record and for determining record relations between the record expressions based on the free-text documents;

an analysis engine for analyzing the record expressions and the record relations also based on the knowledge-base relations to detect an irregularity in the record;

a notifier for providing a notification to a user in dependence on an output of the analysis engine.

In current practice, irregularities in data are often not detected, because such irregularities often can only be detected by studying multiple documents in the file. If a physician wants to cross check his or her current observations with findings and supportive data in earlier and/or free text reports, the physician has to look up these reports in the medical record system and read the complete reports, or the physician needs to consult with colleagues.

Existing systems that check data consistency, completeness or correctness only work on structured data entered in single-source electronic forms. Safeguarding cross source consistency, completeness, and correctness would require the physician to manually check for these issues each time (s)he enters new information. Because documentation is created under high time pressure such cross checks are often not performed in practice. As a consequence, potential issues may go unnoted at the time of report creation. Later on however such issues can have a huge impact on patient care.

The present system provides a way of analyzing documents including for example dictated reports and extract from such free-form text the “knowledge” about the patient's condition and received care that is documented in the patient's medical record. This knowledge is matched against relations and expressions in the knowledge base in order to assess whether any irregularities, such as omissions, exist in the record. Such irregularities go beyond database logical data models. Rather, the system finds irregularities in the actual content of the documents, for example omissions or mistakes in clinical history, findings, diagnosis, treatment, and/or medications. It will be understood that in the present description, “knowledge-base expressions” and “knowledge-base relations” denote expressions and relations stored in the knowledge base. Moreover, it will be understood that in the present description, “record expressions” and “record relations” relate to expressions and relations represented by free-text documents and/or structured documents in a record.

The natural language processor may be arranged for extracting expressions and/or record relations matching knowledge-base expressions and/or knowledge-base relations, respectively. The natural language processor may be implemented more efficiently by making it extract specifically those expressions and/or relations for which corresponding expressions and/or relations exist in the knowledge base. This is more efficient because expressions and/or relations which are not available in the knowledge-base are ignored by the analysis engine.

The natural language processor may be arranged for generating a semantic network of the record expressions and record relations, the knowledge base may comprise constraints on the semantic network, and the analysis engine may be arranged for applying the constraints. This is an example of how the information from the free-text documents can be represented internally as an intermediate step to find irregularities.

The analysis engine may be arranged for detecting an error in the record based on the knowledge-base relations, the record relations, and the record expressions, wherein the knowledge-base relations define constraints on the record relations and record expressions, and the error comprises a violation of at least one of the constraints. An error, for example a medical mistake, can be detected in this way. Such an error should preferably be corrected. Correction can be performed or initiated by a clinician who is notified by the system. Alternatively, the system may be arranged for making corrections automatically based on predetermined correction rules.

The analysis engine may be arranged for detecting an incompleteness in the record based on the knowledge-base relations, the record relations, and the record expressions, wherein the knowledge-base relations define the expressions and/or relations necessary to make the record complete in view of the record expressions and the record relations. This way, the user may be notified of the presence of an incompleteness. The user may be further notified of any suggestion of data which is necessary to remove the incompleteness.

The analysis engine may be arranged for detecting an inconsistency when the record relations and the record expressions lead to a contradiction. Such inconsistencies may be detected without referring to the knowledge-base relations. When the expressions and their relations in a record are not consistent, this can be detected and notified to the user.

The analysis engine may be arranged for determining a severity level of the irregularity, and the notifier may be arranged for providing different notifications for different severity levels. The severity level may relate to an importance or impact the issue has or may have on patient care. Existing systems often produce a large number of alerts resulting in “alert fatigue” among the users. As a consequence, alerts produced by such existing systems are often ignored by the users or the systems are turned off. By providing different notifications for different severity levels, the user immediately knows what kind of response is needed for a particular notification.

The system may comprise a document display unit for displaying at least part of a document of the record, and wherein the notification relates to the document being displayed, and wherein the notifier is arranged for providing the notification while the document is being displayed. This may be a good time to provide the notification, because the clinician is already spending time on reading the document's content, so (s)he may be more open to receive additional information about irregularities relating thereto.

The system may comprise a document editor operatively coupled to the document display unit, for enabling a user to edit a free-text document of the record. The natural language processor and the analysis engine may be arranged for processing the free-text document while it is being edited. The notifier may be arranged for providing the notification as soon as an irregularity is detected relating to the free-text document being edited. This allows detecting any irregularities as soon as they are created; consequently, they may be corrected before the document is stored in the record. This way, the quality of the records may be improved.

The analysis engine may be arranged for generating a correction proposal to remove the irregularity. This is more user-friendly and may be more time-efficient for the user. The notifier may be arranged for showing the correction proposal to a user.

The knowledge base may comprise a representation of a clinical guideline, the entity may comprise a patient, the record may comprise a medical patient record, and the free-text document may comprise a medical report about the patient. However, the medical application is merely an important example of an application. The system may be applied to different knowledge domains, such as a legal knowledge domain, which may be used in lawyers' document systems in the way set forth.

In another aspect, the invention provides a workstation comprising the system set forth. The workstation may be implemented as a standalone system performing the analysis locally, while communicating with a patient database. The system may also be implemented in a distributed computer system.

In another aspect, the invention provides a method of verifying document content, using

a knowledge base comprising a collection of knowledge-base expressions and a collection of knowledge-base relations between the knowledge-base expressions; and

a database comprising a record with documents comprising information relating to an entity, the documents including free-text documents and/or structured documents;

the method comprising

extracting record expressions from free-text documents stored in the record and determining a plurality of record relations between the expressions based on the free-text documents;

analyzing the record expressions and the record relations also based on the knowledge-base relations to detect an irregularity in the record; and

providing a notification to a user in dependence on an output of the analysis engine.

In another aspect, the invention provides a computer program product comprising instructions for causing a processor system to perform the method set forth.

It will be appreciated by those skilled in the art that two or more of the above-mentioned embodiments, implementations, and/or aspects of the invention may be combined in any way deemed useful.

Modifications and variations of the image acquisition apparatus, the workstation, the system, the method, and/or the computer program product, which correspond to the described modifications and variations of the system, can be carried out by a person skilled in the art on the basis of the present description.

### BRIEF DESCRIPTION OF THE DRAWINGS

These and other aspects of the invention are apparent from and will be elucidated with reference to the embodiments described hereinafter. In the drawings,

FIG. 1 is a diagram illustrating aspects of a system for verifying document content; and

FIG. 2 is a flowchart of a method of verifying document content.

### DETAILED DESCRIPTION OF EMBODIMENTS

The techniques described herein can be applied to, for example, patient care information systems that support documentation of clinical patient information. Examples include electronic patient/health records, hospital information systems, general practice information systems, specialty specific information systems such as cardiology and/or oncology information systems, and cancer registration systems. However, this is not a limitation. The techniques can also be applied to information systems applied in different application fields.

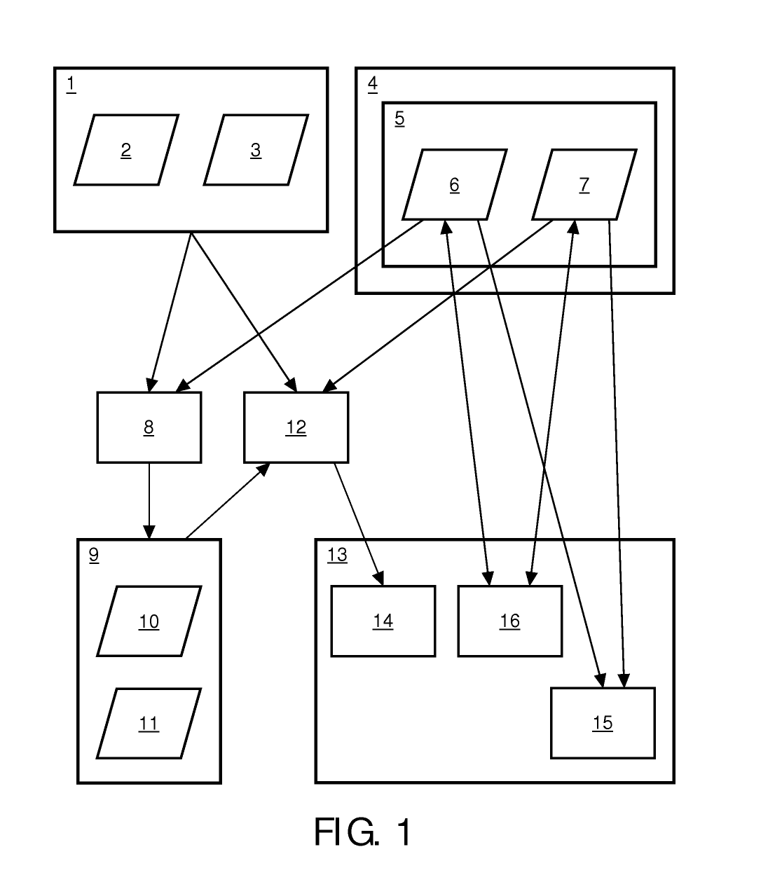

FIG. 1 illustrates a system for verifying document content. The system may be implemented, for example, on a computer workstation or in a distributed computing environment. The workstation may comprise a processor, memory, hard drive, user input device, and/or a display device. The distributed computing environment may comprise a user terminal, which may be a workstation, one or more servers, and a communications network. The system of FIG. 1 may be implemented on the server or on the terminal/workstation. It is also possible that a part of the system is implemented on a server and another part on a workstation. For example, the knowledge base 1, the database 4, the natural language processor 8, and the analysis engine 12 may be implemented on one or more servers, while the user interface 13 comprising a notifier 14 may be implemented on the terminal/workstation. However, other divisions of the system into functional units are equally possible.

The system may comprise a knowledge base 1 comprising a collection of expressions 2 and a collection of relations 3 between the expressions 2. Wherever needed for clarity, these expressions 2 and relations 3 will be referred to herein as knowledge-base expressions 2 and knowledge-base relations 3, respectively. At least part of the knowledge base may have the form and functions of an ontology. The expressions 2 and the relations 3 may be such that the semantics of the expressions is represented in the knowledge base.

The system may comprise a database 4 comprising one or more records. A record 5 may comprise documents with information relating to an entity, such as a patient. Some of the documents may be free-text documents 6, whereas other documents may be structured documents 7. Such a structured document 7 may be a document which is generated by a computer program, based on data the user has provided by filling in an electronic form. For example, the structured document may be an XML document. Structured documents may comprise free-text portions. Such a free-text portion may be regarded as a free-text document encapsulated within a structured document. Consequently, free-text portions of structured documents may be treated by the system as free-text documents, and be subject to processing by the natural language processor 8.

The system may comprise a natural language processor 8 for extracting expressions 10 from free-text documents 6 stored in the record 5. The natural language processor 8 may further determine relations 11 between the expressions 10 found in one or more of the free-text documents in a record. The natural language processor may further determine relations between expressions found in free-text documents 6 and expressions found in structured documents 7 of the same record 5. Wherever needed for clarity, these expressions 10 and relations 11 will be referred to herein as record expressions 2 and record relations 3, respectively. The natural language processor 8 may use an ontology which may be part of the knowledge base 1 to perform its natural language processing. Natural language processing is a technique known in the art per se.

The system may comprise an analysis engine 12 for analyzing the record expressions 10 and the record relations 11. This analysis may also be based on the knowledge-base relations 3 and knowledge-base expressions 2. The analysis engine 12 is arranged for detecting any irregularity in the record 5. Such an irregularity may be an omission or a mistake. The analysis engine 12 may be arranged for evaluating both the expressions 10 and relations 11 produced by the natural language processor 8, as well as any expressions and/or relations explicitly represented in form of structured documents 7 which may be present in the record 5. In some embodiments, the functionality of the natural language processor 8 and the analysis engine 12 may be at least partly merged into a combined analysis module.

The system may comprise a notifier 14 for providing a notification to a user in dependence on an output of the analysis engine 12. For example, the notifier 14 may provide an indication on a display of a user that an irregularity has been detected in a particular record. The notifier 14 may be part of a user interface 13 of a document management system such as a hospital information system. Such a user interface 13 may provide user access to other functionality relating to such a document management system, as is known in the art per se.

In another example, the notifier may generate a list with references to records processed by the system and in which an irregularity was found. For each record, the list may include information on what kind of irregularity was detected and any further details such as the locations of expressions related to the irregularity.

The natural language processor 8 may be arranged for extracting record expressions 10 and/or record relations 11 matching knowledge-base expressions 2 and/or knowledge-base relations 3, respectively. The natural language processor may be arranged for analyzing the knowledge-base expressions 2 and relations 3 in order to establish what expressions and relations to look for in the record 5. This way, processing time is not wasted on expressions and relations which do not play a role in irregularity finding.

The natural language processor 8 may be arranged for generating a semantic network of the record expressions 10 and record relations 11. Such a semantic network puts structure and meaning to the expressions, for example by generating “is-a” or “has-a” relationships between record expressions. The knowledge base 1 may represent constraints on the semantic network, and the analysis engine 12 may be arranged for applying the constraints. The constraints may be derived from clinical guidelines, for example.

The analysis engine 12 may be arranged for detecting an error in the record 5, based on the knowledge-base relations 3, the record relations 11, and the record expressions 10, wherein the knowledge-base relations 3 define constraints on the record relations 11 and record expressions 10, and the error comprises a violation of at least one of the constraints. Such error detection may be achieved by mapping a semantic network generated from the record expressions 10 and record relations 11 against the allowable relations and expressions represented by the knowledge base. It is also possible that the knowledge base contains representations of expressions and/or relations which are forbidden, i.e., which result, by definition, in an error.

The system according to claim 1, wherein the analysis engine 12 is arranged for detecting an incompleteness in the record 5, based on the knowledge-base relations 3, the record relations 11, and the record expressions 10, wherein the knowledge-base relations 3 define the expressions and/or relations necessary to make the record 5 complete in view of the record expressions 10 and the record relations 11. For example, the knowledge base 1 may contain a rule which allows a particular diagnosis to be concluded when a particular set of evidence has been gathered. If the record 5 does contain the diagnosis, but the description of gathered evidence is not sufficient to warrant the diagnosis, the analysis engine 12 may conclude that a part of the evidence is missing, and hence the record 5 is incomplete.

The analysis engine 12 may be arranged for detecting an inconsistency when the record relations 11 and the record expressions 10 lead to a contradiction. Such a logical contradiction may be detected without the use of the knowledge base 1. However, some inconsistencies may use the knowledge base to be able to take into account synonyms, for example.

The analysis engine 12 may be arranged for determining a severity level of the irregularity. This enables the notifier 14 to provide different kinds of notification for different severity levels. For example, when the diagnosis is not correct in view of the described findings, this may be a high-level irregularity, whereas an inconsistency between findings which do not play an important role in the diagnosis or treatment can be classified as a low-level irregularity. The notifier may disrupt the workflow of the clinician by means of a pop-up window, for example, if a high-level irregularity is detected, whereas an icon in the corner of the screen may be used to notify a low-level irregularity.

The system may comprise a document display unit 15. This unit 15 may be part of the user interface 13. The document display unit 15 is used for displaying at least part of a document 6, 7 of the record 5. For example, a text viewing program is used, which may enable a user to scroll through the document. The notifier 14 may be arranged to produce a notification for a document 6, 7 as soon as the document 6, 7 is requested for viewing by the document display unit 15. This way, it may be avoided that a user draws conclusions from the erroneous information in the document.

The system may comprise a document editor 16 operatively coupled to the document display unit 15, for enabling a user to edit a free-text document 6 of the record 5. The document editor 16 may be part of the user interface 13 and may include a speech-to-text conversion tool to allow the user to input the document by means of dictation. The free-text document 6 may be a free-text document 6 encapsulated in a structured document 7. The natural language processor 8 and the analysis engine 12 may be arranged for processing the free-text document 6 while it is being edited. As new text is being inputted into the system by means of the document editor 16, the new text is analyzed using the natural language processor 8 and the analysis engine 12. This new text is thus checked, taking into account the information which is already present in the record. This allows the notifier 14 to provide the notification as soon as an irregularity comes into existence and while the free-text document 6 is being edited.

The analysis engine 12 may be arranged for generating a correction proposal to remove the irregularity. Sometimes the knowledge base contains sufficient information to generate an educated guess of how the irregularity should be corrected. In such a case, this proposal may be made by an indication generated by the notifier 14. It is also possible to make the correction automatically. In the latter case, the notifier 14 may report the correction to a user.

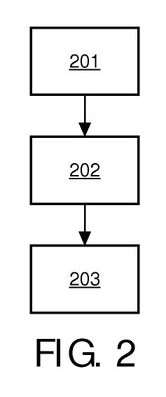

FIG. 2 shows a flowchart of a method of verifying document content, using a knowledge base and a database as set forth. As shown in the figure, the method may comprise a step 201 of extracting record expressions from free-text documents stored in the record and determining a plurality of record relations between the expressions, based on the free-text documents. The method further may comprise a step 202 of analyzing the record expressions and the record relations also based on the knowledge-base relations to detect an irregularity in the record. The method may further comprise a step 203 of providing a notification to a user in dependence on an output of the analysis engine. The method may be implemented at least partly in form of a computer program. The method and computer program may be extended or modified with the functionalities described herein with respect to the system.

The methods and systems described herein may use external knowledge (e.g. clinical practice guidelines, international standards or cross-patient relational patterns), represented in a knowledge base, to cross check the information entered by a physician with the patient's medical record for inconsistencies, incompleteness or correctness.

Free text data in the patient medical record or in the current working document may be analyzed by using natural language processing or semantic search. The notifier provides the physician with notifications and/or suggestions for improvement. Notifications can be provided on-the-fly (prospectively) during documentation/dictation and/or retrospectively. The notifications may include a severity warning of the issue detected. Based on the severity, the alerts are presented in a different way to the user (e.g. unobtrusive alerts for minor inconsistencies and obtrusive alerts for severe inconsistencies). The notifications may include an explanation of why the warning was generated, with references to the parts in the medical record (e.g. relevant reports and documents with inconsistency highlighted) for verification, as well as a reference to the relevant clinical guideline(s). Moreover the notification may provide a recommendation for a consistent or correct documentation.

The proposed method helps to ensure data consistency, completeness and/or correctness throughout the medical record, thereby improving the quality of care. At the same time, the proposed method may improve the efficiency of care, since physicians may spend less time trying to figure out any issues. The proposed method may also minimize the risk that these issues go unnoted and thereby reduces the probability that these issues cause any medical errors. Finally, the proposed method may detect a level of severity of the potentially detected issues which can be used to provide different ways of alerting the user (unobtrusive for low-severity alerts and obtrusive for severe alerts), thereby preventing alert fatigue among the users.

One example of how the techniques described herein can be implemented applies to a tumor documentation system. Tumor documentation is the structured organ-specific documentation of cancer patient information. The tumor documentation may comprise a user interface screen with fields enabling the user to provide some structured information (such as the last name and initials of the patient) and some free-form text (such as a report of a clinical session). As an example, the lower part of the user interface screen may be reserved for displaying warnings generated by the notifier. Different colors in which the warnings are displayed may be used to provide an indication of the warning level. In a first example, the analysis engine may have found an inconsistency between T stage and the tumor size. A suggestion is provided for the correct T stage or the user is suggested to check the tumor size. In this example, the knowledge base comprises a representation of the international TNM staging rules definition. The notification is shown with a yellow symbol to indicate an issue having a medium impact on patient care. In a second example, the tumor size entered in the presently edited document is not the same as the tumor size detected in the radiology report. A notification with a yellow symbol to indicate medium impact on patient care is shown. The notification includes a link provided to the radiology report in which the inconsistency is found. Upon clicking on the link the radiology report is opened and the problem is highlighted. This way, an indication is given of the documents containing expressions relevant to the irregularity. In a third example, two knowledge databases are used to enable more complex analysis. In this case, a representation of the TNM staging rule base definitions is combined with a representation of a set of clinical practice guidelines. In these guidelines, typically the TNM stage is linked to an applicable follow-up treatment (evidence based). In this hypothetical example, a different N stage (either N2 or N3) will result in different guideline treatment recommendations, which will have a huge impact on patient care. The system detects, based on the available information in the patient record and the TNM staging rule, that the documented N stage does not fit with the number of lymph nodes documented. According to the clinical practice guideline, this impacts the treatment choice; consequently, a higher level warning is generated using a red colored symbol.

The techniques disclosed herein provide an irregularity or omission finding functionality for clinical documentation, checking consistency, completeness and correctness and improving the quality across the entire medical record. The system may analyze free text and structured information and data across the medical record and detect and establish the aforementioned issues by the application of external knowledge such as documented in clinical practice guidelines. The techniques may be used to detect inconsistencies across multiple heterogeneous information and data sources that compose a medical record and multiple external knowledge sources and to provide a level of severity of inconsistency based on the impact on patient care and optionally a recommendation on how to resolve the data issue detected.

Prospectively, the techniques may be used to safeguard quality of clinical documentation at the time new information is entered into the patient medical record. Retrospectively, they may be used to prevent inconsistencies from being unnoted or resulting in medical errors, e.g. when historical patient information is used in decision making.

It will be appreciated that the invention also applies to computer programs, particularly computer programs on or in a carrier, adapted to put the invention into practice. The program may be in the form of a source code, an object code, a code intermediate source and object code such as in a partially compiled form, or in any other form suitable for use in the implementation of the method according to the invention. It will also be appreciated that such a program may have many different architectural designs. For example, a program code implementing the functionality of the method or system according to the invention may be sub-divided into one or more sub-routines. Many different ways of distributing the functionality among these sub-routines will be apparent to the skilled person. The sub-routines may be stored together in one executable file to form a self-contained program. Such an executable file may comprise computer-executable instructions, for example, processor instructions and/or interpreter instructions (e.g. Java interpreter instructions). Alternatively, one or more or all of the sub-routines may be stored in at least one external library file and linked with a main program either statically or dynamically, e.g. at run-time. The main program contains at least one call to at least one of the sub-routines. The sub-routines may also comprise calls to each other. An embodiment relating to a computer program product comprises computer-executable instructions corresponding to each processing step of at least one of the methods set forth herein. These instructions may be sub-divided into sub-routines and/or stored in one or more files that may be linked statically or dynamically. Another embodiment relating to a computer program product comprises computer-executable instructions corresponding to each means of at least one of the systems and/or products set forth herein. These instructions may be sub-divided into sub-routines and/or stored in one or more files that may be linked statically or dynamically.

The carrier of a computer program may be any entity or device capable of carrying the program. For example, the carrier may include a storage medium, such as a ROM, for example, a CD ROM or a semiconductor ROM, or a magnetic recording medium, for example, a floppy disc or a hard disk. Furthermore, the carrier may be a transmissible carrier such as an electric or optical signal, which may be conveyed via electric or optical cable or by radio or other means. When the program is embodied in such a signal, the carrier may be constituted by such a cable or other device or means. Alternatively, the carrier may be an integrated circuit in which the program is embedded, the integrated circuit being adapted to perform, or to be used in the performance of, the relevant method.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

1. A system for detecting an irregularity in a record, comprising
a knowledge base comprising a collection of expressions, hereinafter referred to as knowledge-base expressions and a collection of relations, hereinafter referred to as knowledge-base relations between the knowledge-base expressions;
a database comprising a record with documents, the documents comprising information relating to an entity, the documents including free-text documents (6);
a natural language processor for extracting expressions, hereinafter referred to as record expressions from the free-text documents stored in the record and for determining relations, hereinafter referred to as record relations between the record expressions based on the free-text documents, wherein the natural language processor is arranged for using an ontology to perform its natural language processing;
an analysis engine for analyzing the record expressions and the record relations also based on the knowledge-base relations to detect an irregularity in the record, wherein the analysis engine is arranged for detecting an error in the record based on the knowledge-base relations, the record relations, and the record expressions, wherein the knowledge-base relations define constraints on the record relations and record expressions, and the error comprises a violation of at least one of the constraints; and
a notifier for providing a notification on a display that an irregularity has been detected in the record, in dependence on an output of the analysis engine.

2. The system according to claim 1, wherein the natural language processor is arranged for extracting record expressions and/or record relations matching knowledge-base expressions and/or knowledge-base relations, respectively.

3. The system according to claim 2, wherein the natural language processor is arranged for generating a semantic network of the record expressions and record relations, and wherein the knowledge base comprises constraints on the semantic network, and wherein the analysis engine is arranged for applying the constraints.

4. (canceled)

5. The system according to claim 1, wherein the analysis engine is arranged for detecting an incompleteness in the record, based on the knowledge-base relations, the record relations, and the record expressions, wherein the knowledge-base relations define the expressions and/or relations necessary to make the record complete in view of the record expressions and the record relations.

6. The system according to claim 1, wherein the analysis engine is arranged for detecting an inconsistency when the record relations and the record expressions lead to a contradiction.

7. The system according to claim 1, wherein the analysis engine is arranged for determining a severity level of the irregularity, and wherein the notifier is arranged for providing different notifications for different severity levels.

8. The system according to claim 1, further comprising a document display unit for displaying at least part of a document of the record, and wherein the notification relates to the document being displayed, and wherein the notifier is arranged for providing the notification while the document is being displayed.

9. The system according to claim 8, further comprising a document editor operatively coupled to the document display unit, for enabling a user to edit a free-text document of the record, and wherein the natural language processor and the analysis engine are arranged for processing the free-text document while it is being edited, and wherein the notifier is arranged for providing the notification as soon as an irregularity is detected relating to the free-text document being edited.

10. The system according to claim 1, wherein the analysis engine is arranged for generating a correction proposal to remove the irregularity, based on the knowledge base.

11. The system according to claim 10, wherein the notifier is arranged for showing the correction proposal to a user.

12. The system according to claim 1, wherein the knowledge base comprises a representation of a clinical guideline, wherein the entity comprises a patient, wherein the record comprises a medical patient record, and wherein the free-text document comprises a medical report about the patient.

13. A workstation comprising the system according to claim 1.

14. A method of detecting an irregularity in a record, using
a knowledge base comprising a collection of expressions, hereinafter referred to as knowledge-base expressions and a collection of relations, hereinafter referred to as knowledge-base relations between the knowledge-base expressions; and
a database comprising a record with documents, the documents comprising information relating to an entity, the documents including free-text documents;
the method comprising
extracting expressions, hereinafter referred to as record expressions from the free-text documents stored in the record and determining a plurality of relations, hereinafter referred to as record relations between the record expressions based on the free-text documents, wherein an ontology is used to perform natural language processing;
analyzing the record expressions and the record relations also based on the knowledge-base relations to detect an irregularity in the record, wherein the analyzing comprises detecting an error in the record based on the knowledge-base relations, the record relations, and the record expressions, wherein the knowledge-base relations define constraints on the record relations and record expressions, and the error comprises a violation of at least one of the constraints; and
providing a notification on display that an irregularity has been detected in the record in dependence on an output of the analysis.

15. A computer program product comprising instructions for causing a processor system to perform the method according to claim 14.
